(19) United States
(12) Patent Application Publication
(10) Pub. No.: US 2023/0227757 A1
(43) Pub. Date: Jul. 20, 2023

(54) METHOD FOR MAKING A GEL OR A GEL-LIKE DETERGENT

(71) Applicant: RECKITT BENCKISER FINISH B.V., Hoofddorp (NL)

(72) Inventors: Alias Younis AL-BAYATI, Heidelberg (DE); Torsten ROTH, Heidelberg (DE); Alexander WINK, Heidelberg (DE)

(21) Appl. No.: 18/001,882

(22) PCT Filed: Jun. 21, 2021
(86) PCT No.: PCT/EP2021/066863

§ 371 Date: Dec. 15, 2022

(30) Foreign Application Priority Data
Jul. 1, 2020 (GB) 2010046.7

(51) Int. Cl. C11D 17/00; C11D 17/04; C11D 11/00; C11D 17/08; C11D 1/66

(52) U.S. Cl. CPC C11D 17/003; C11D 17/043; C11D 11/0035; C11D 17/08; C11D 1/66

(57) ABSTRACT

A method of forming a gel or gel-like detergent composition comprising: dosing a solid composition, and dosing a liquid composition; into a water-soluble container.

The present invention relates to a method of forming a gel or gel-like composition, a detergent comprising such a gel and the use of such a detergent.

Detergents, in particular automatic dishwashing products, that have a smooth, continuous visual appearance, such as gels, are typically more aesthetically appealing to consumers than compositions in granular, powder or tablet form. They also can be faster-dissolving in use. Monodose detergents, such as those contained within a water-soluble material, comprising a gel format are particularly attractive to consumers, since their relatively high viscosity gives the appearance of highly concentrated detergents.

In order to achieve a high level of cleaning and shine performance, automatic dishwashing products need to contain significant quantities of active ingredients such as builders, co-builders, surfactants, polymers, enzymes, bleaching compounds and sometimes anti-corrosion or glass-protecting agents. In a multi-compartment format comprising a gel compartment at least some of the actives need to be in the gel phase to achieve the required performance of the multi-benefit product. However, the types and amounts of active ingredients that can be included are also constrained by the risk of gel instability and phase separation due to the solubility issues.

In addition to this, the overarching technical hurdle to the use of gels in monodose containers has been the difficulties with dosing a gel due to its increased viscosity compared to, for example, the dosing of liquids or powders. Accordingly, the processing and dosing of gel or gel-like composition is laborious and there is a low level of solids that can be included in the gel or gel-like composition without negatively impacting the processing and filling steps. Typically, if the quantity of solids is increased beyond a certain point it can lead to the formation of a separate phase of free liquid that then negatively impacts the consumer impression of the product.

Thus, there is a need for a method to limit the occurrence and visibility of phase separation in gels or gel-like compositions and simultaneously provide an improved method of dosing such compositions.

Herein, the term ‘gel’ is not limited to a three-dimensional network which behaves like a solid and that exhibits no flow in the steady-state and may be considered to be a thickened liquid, which may have suspended solids.

The term ‘gel-like’ refers to a combination of liquid and solid, or a suspension of solid-in-liquid, that has the appearance of a gel.

Methods to tackle phase separation in gels rely on impacting Stokes' Law, an expression that describes the frictional force on spherical objects with very small Reynolds numbers in a viscous fluid:

$$v = \frac{g \cdot Δ Q \cdot {d}^{2}}{18 η}$$

g—gravitational constant
ΔQ—solid-liquid density difference
d—diameter of the solid particle
η—viscosity

Accordingly, in order to delay the phase separation of liquids or gels comprising suspended solid materials, try to increase the viscosity (η) of the medium.

Common approaches are: the use of an increased quantity of solids to increase the viscosity of the composition; addition of a liquid absorbing agent; addition of a structuring or thickening agent that build a microstructure in the composition via weak physical crosslinking; and/or addition of a high melting additive mixed into the composition in its molten state.

However, such approaches outlined above suffer from certain limitations. For example, the storage of such compositions in harsh conditions (elevated temperature, high humidity) accelerates the irreversible phase separation of solid-liquid suspensions, while the introduction of further non-functional ingredients (thickening and structuring agents) increases the formula cost and provides manufacturing complexity while not providing a functional benefit to the consumer. Furthermore, compositions with a high solid-to-liquid ratio result in dosing difficulties due to a high viscosity and/or the high solid content.

The present invention addresses these problems through the provision of a method of forming a gel or gel-like detergent composition comprising: dosing a solid composition, and dosing a liquid composition; into a water-soluble container.

The methods of dosing of liquids and solids are well established in the technical field. However, the present invention circumvents the problems of a heterogeneous composition (e.g. precipitation of solids, phase separation, sedimentation, untimely structuring of gel, limiting threshold of solid content, and clogging of pipes, etc.).

The solid composition may comprise a single or multiple components. The liquid composition may be of any suitable viscosity where the composition can be poured.

The present method permits an increased solid-to-liquid ratio and so a higher level of solid actives in the gel, with the resulting heterogeneous mixture displaying less phase separation. The use of a non-functional structuring and/or thickening agent is not necessary meaning that the prepared composition is more efficacious.

Furthermore, compositions which would not be processable or dose-able as a combined composition can be produced potentially enabling a higher actives content. The claimed method also permits separate dosing of materials with an otherwise undesired particle size or bulk density or indeed of incompatible/reactive components into the desired compartment, which may subsequently interact.

Preferably, the gel or gel-like composition is an automatic dishwashing detergent. The gel or gel-like composition may be a homogeneous gel or solid-in-liquid dispersion.

Advantageously, the dosing of the solid composition occurs before the dosing of the liquid composition. It is preferred that the solid composition and the liquid composition are dosed from separate nozzles.

Alternatively, the solid composition and the liquid composition are dosed simultaneously into the container, thus omitting a pre-mixing stage.

Preferably, the dosing occurs as the water-soluble container is moving on an endless surface. In such an embodiment the claimed method may be incorporated in an industrial process for preparing detergent compositions.

The solid composition advantageously comprises a builder.

The builder is advantageously selected from the group consisting of methylglycine diacetic acid (MGDA), N,N-dicarboxymethyl glutamic acid (GLDA), citrate and combinations of two or more thereof. It is to be appreciated that the terms MGDA, GLDA and citrate encompass the free acids as well as salts, esters and derivatives thereof. Preferably, the citrate is trisodium citrate.

Other phosphorous-free builders include succinate-based compounds. The terms “succinate-based compound” and “succinic acid based compound” are used interchangeably herein.

Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (M IDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further succinate compounds have the formula:

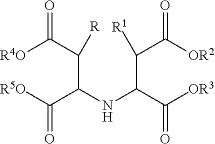

in which R, R1, independently of one another, denote H or OH; R2, R3, R4, R5, independently of one another, denote a cation, hydrogen, alkali metal ions and ammonium ions, ammonium ions having the general formula R⁶R⁷R⁸R⁹N⁺ and R6, R7, R8, R9, independently of one another, denote hydrogen, alkyl radicals having 1 to 12 C atoms or hydroxyl-substituted alkyl radicals having 2 to 3 C atoms.

Examples include tetrasodium imminosuccinate. Iminodisuccinic acid (IDS) and (hydroxy)iminodisuccinic acid (HIDS) and alkali metal salts or ammonium salts thereof are especially preferred succinate-based builder salts. The phosphorous-free co-builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts.

Most preferably, however, the builder is a carboxylate, such as citrate, and/or an aminocarboxylate, such as methylglycine diacetic acid. The builder is preferably present in an amount of from 20 to 80% by weight, such as 30 to 70% by weight, or even from 40 to 65% by weight

The gel or gel-like composition preferably does not comprise a bleaching agent. Due to the decomposition of bleaching agent such components cause the generation of gas and the build-up of pressure results in the bursting of pouch. In contrast, a compartment containing only solid can be punctuated to allow the escape of gases, but this would lead to the leaking of a gel or gel-like composition.

The composition may however comprise one or more bleach activators and/or bleach catalysts. Any suitable bleach activator may be included, for example TAED, if this is desired for the activation of the bleaching agent. Any suitable bleach catalyst may be used, for example manganese acetate or dinuclear manganese complexes such as those described in EP 1741774 A1.

The composition may include one or more enzymes. It is preferred that the one or more enzymes are selected from proteases, lipases, amylases, cellulases and peroxidases, with proteases and amylases being most preferred. It is most preferred that protease and/or amylase enzymes are included in the compositions according to the invention as such enzymes are especially effective in dishwashing detergent compositions. More than one species may be used. The total quantity of enzymes is preferably from 0.5 to 10% by weight, such as 1 to 5%, or even from 2 to 4%.

The solid composition is preferably comprised of particles having an average initial diameter of from 100 μm to 1500 μm, such as from 120 μm to 1450 μm, from 150 μm to 1400 μm, from 170 to 1300 μm, preferably from 200 μm to 1200 μm. The initial particle size refers to the average size before it is incorporated in the claimed method. Particles within these ranges have the advantage of being dosed into a container at a fast speed and having a high degree of wettability. Particles outside this range may either result in health hazards or block the dosing equipment.

The liquid composition may include one or more surfactants. Any of non-ionic, anionic, cationic, amphoteric or zwitterionic surface active agents or suitable mixtures thereof may plausibly be used. In general, bleach-stable surfactants are preferred.

In the case of automatic dishwashing compositions, it is preferred to minimise the amount of anionic surfactant. Accordingly, preferably the composition comprises no more than 2 wt %, no more than 1 wt %, or no, anionic surfactant. Preferably the composition comprises no more than 5 wt %, no more than 1 wt %, or no, ionic surfactant of any type.

The liquid composition preferably comprises a non-ionic surfactant.

Preferably, the non-ionic surfactant is an optionally end capped alkyl alkoxylate. A preferred class of nonionic surfactants is ethoxylated non-ionic surfactants prepared by the reaction of a monohydroxy alkanol or alkyl phenol with 6 to 20 carbon atoms. Preferably the surfactants have at least 12 moles per mole of alcohol or alkyl phenol. Particularly preferred non-ionic surfactants are the non-ionics from a linear chain fatty alcohol with 10-20 carbon atoms and at least 5 moles, of ethylene oxide per mole of alcohol. According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Preferably, the one or more nonionic surfactants comprises a mixed alkoxylate fatty alcohol non-ionic surfactant, preferably comprising a greater number of moles of the lower alkoxylate group than of the higher alkoxylate group in the molecule. Preferably the mixed alkoxylate fatty alcohol non-ionic surfactant comprises at least two of EO, PO or BO groups and most preferably only EO and PO groups.

By the term ‘higher alkoxylate’ it is meant the alkoxylate group having the greatest number of carbon atoms in that alkoxylate group. By the term ‘lower alkoxylate’ it is meant the alkoxylate group having the lowest number of carbon atoms in that alkoxylate group. Thus, for a mixed alkoxylate fatty alcohol com-prising ethoxylate (EO) and propoxylate (PO) groups the EO is the lower alkoxylate and the PO is the higher alkoxylate. Thus, the detergent compositions of the invention comprise mixed alkoxylate fatty alcohols comprising a greater number of EO groups than PO groups. The same applies to other mixed alkoxylates such as those containing EO and butoxylate (BO) or even PO and BO groups.

The mixed alkoxylate fatty alcohol non-ionic surfactant preferably has a mole ratio of the lower alkoxylate group to the higher alkoxylate group is at least 1.1:1, most preferably of at least 1.8:1, especially at least 2:1. It is also preferred that the mixed alkoxylate fatty alcohol non-ionic surfactant comprises between 3 to 5 moles of the higher alkoxylate group and between 6 to 10 moles of the higher lower group, preferably 4 or 5 moles of PO and 7 or 8 moles of EO and most preferably 4 moles of PO and 8 moles of EO.

Preferably the mixed alkoxylate fatty alcohol non-ionic surfactant has 12-18 carbon atoms in the alkyl chain.

It is especially preferred that the mixed alkoxylate fatty alcohol nonionic surfactant comprises at least two of EO, PO or BO groups and especially a mixture of EO and PO groups, preferably EO and PO groups only.

It is most preferred that the mole ratio of the lower alkoxylate group to the higher alkoxylate group is at least 1.1:1, more preferably at least 1.5:1, and most preferably at least 1.8:1, such as at least 2:1 or even at least 3:1.

An especially preferred mixed alkoxylate fatty alcohol nonionic surfactant according to the present invention comprises between 3 to 5 moles of the higher alkoxylate group and between 6 to 10 moles of the lower group. Especially preferred are mixed alkoxylate fatty alcohol nonionic surfactants having 4 or 5 moles of the higher alkoxylate group and 7 or 8 moles of the lower alkoxylate group. According to one aspect of the invention a mixed alkoxylate fatty alcohol nonionic surfactant having 4 or 5 PO moles and 7 or 8 EO moles is especially preferred and good results have been obtained with for surfactants with 4 PO moles and 8 EO moles.

In an especially preferred embodiment, the mixed alkoxylate fatty alcohol nonionic surfactant is C12-15 8EO/4PO.

Surfactants of the above type which are ethoxylated mono-hydroxy alkanols or alkylphenols which additionally comprise polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

The mixed alkoxylate fatty alcohol non-ionic surfactants used in the compositions of the invention may be prepared by the reaction of suitable monohydroxy alkanols or alkylphenols with 6 to 20 carbon atoms. Preferably the surfactants have at least 8 moles, particularly preferred at least 10 moles of alkylene oxide per mole of alcohol or alkylphenol.

Particularly preferred liquid mixed alkoxylate fatty alcohol non-ionic surfactants are those from a linear chain fatty alcohol with 12-18 carbon atoms, preferably 12 to 15 carbon atoms and at least 10 moles, particularly preferred at least 12 moles of alkylene ox-ide per mole of alcohol.

When PO units are used, they preferably constitute up to 25% by weight, preferably up to 20% by weight and still more preferably up to 15% by weight of the over-all molecular weight of the non-ionic surfactant.

The claimed mixed alkoxylate fatty alcohol non-ionic surfactants, and especially the C12-15 fatty alcohol 8EO,4PO surfactant exhibit: excellent wetting of plastic, glass, ceramic and stainless steel; excellent temperature stability up to 90° C. for processing; good compatibility with thickeners typically used in the detergent compositions (e.g. PEG); and stability in alkaline conditions.

Alternatively, glucamide surfactants prepared from sugars and natural oils, may be used. A preferred example is oleyl glucamide. Also suitable are alkyl polyglycosides (APGs), which are plant-derived from sugars, these surfactants are usually glucose and fatty alcohol derivatives.

The use of a mixture of any of the aforementioned nonionic surfactants is suitable in compositions of the present invention. The non-ionic surfactants are preferably present in an amount of from 20 to 95% by weight, such as from 25 to 80% by weight.

The gel or gel-like composition preferably does not contain a non-functional structuring or thickening agent.

Preferably, the gel or gel-like composition has a density of greater that 1 g/cm³, such from 1.1 to 1.5 g/cm³, preferably from 1.2 to 1.35 g/cm³, or even from 1.25 to 1.3 g/cm³. The higher density permits a higher quantity of active ingredients to be include in a set volume and thus results in a composition with an increased efficacy.

In a second aspect of the invention there is provided a detergent composition prepared by a method as described herein. Advantageously, the gel or gel-like composition is contained in a water-soluble pouch, preferably a multi-chamber water-soluble pouch.

In a third aspect there is provided the use of a detergent composition as described here in an automatic dishwasher.

The invention is demonstrated in the following, non-limiting Examples.

### EXAMPLES

Benchmark

A gel or gel-like composition suitable for use in a commercial multi-component detergent composition was taken as a benchmark. The components of the reference gel are set out in Table 1.

TABLE 1

| Component | Percentage by weight (wt. %) |
|---|---|
| Solid component (trisodium citrate | 57.30 |
| builder, bleach activator and catalyst) | |
| Liquid component (surfactant, | 42.70 |
| thickening agent and auxiliaries) | |

Despite the fact that the composition comprises a thickening agent, the benchmark displays rapid phase separation and formation of a surfactant-based supernatant during storage at 40° C., even after prolonged prior storage at room temperature (25° C.). The phase separation results in significant processability problems, as well as aesthetic issues.

Dosing

The sequential dosing of the ingredients of the benchmark composition was investigated.

The solid components were dosed into a compartment composed of polyvinyl alcohol and subsequently in a second step, the liquid components were added on top.

This method resulted in a suitable gel-like composition with suitable aesthetic appearance. This approach eliminated the pre-mixing step of the ingredients and facilitates the processing and dosing stages in an industrial process. The method results in a composition with higher solid content and so an increased higher density of active ingredients per load, and so increased efficacy, and means that the liquid content can be drastically reduces and eliminates the need for a pumpable gel.

Composition Stability

In the first step, 10 g, 15 g and 20 g trisodium citrate were filled into containers and 90 g, 85 g and 80 g, respectively, of the benchmark gel were added to 100 mL containers.

The cylinders were stored at either 25° C. and 40° C. for 5 or 6 days and the volume of formed supernatant measured. The results are set out in Table 2.

TABLE 2

| | Storage Conditions | Supernatant (mL) |
|---|---|---|
| 100 g of benchmark gel | 25° C./5 d | 15 ± 2 |
| | 40° C./5 d | 16 ± 2 |
| 90 g of gel + 10 g citrate | 25° C./6 d | 8 ± 2 |
| | 40° C./6 d | 8 ± 2 |
| 85 g of gel + 15 g citrate | 25° C./6 d | 5 ± 2 |
| | 40° C./6 d | 7 ± 2 |
| 80 g of gel + 20 g citrate | 25° C./6 d | 3 ± 2 |
| | 40° C./6 d | 4 ± 2 |

Significantly, whereas the benchmark rapidly displayed a clear phase separation and formation of a liquid layer, the inventive method resulted in a comparatively smaller and more aesthetically pleasing supernatant layer.

The claimed method therefore serves to both mask the visibility of phase separation and permit the inclusion of an increased level of solid actives in the gel.

The invention is defined by the claims.

1. A method of forming a gel or gel-like detergent composition, the method comprising:
dosing a solid composition; and
dosing a liquid composition
into a water-soluble container.

2. The method according to claim 1, wherein the gel or gel-like composition is an automatic dishwashing detergent.

3. The method according to claim 1, wherein the dosing of the solid composition occurs before the dosing of the liquid composition.

4. The method according to claim 1, wherein the solid composition and the liquid composition are dosed from separate nozzles.

5. The method according to claim 1, wherein the dosing occurs as the water-soluble container is moving on an endless surface.

6. The method according to claim 1, wherein the solid composition comprises a builder and/or a bleach activator.

7. The method according to claim 1, wherein the solid composition comprises particles having an average diameter of from 200 μm to 1200 μm.

8. The method according to claim 1, wherein the liquid composition comprises a non-ionic surfactant.

9. The method according to claim 1, wherein the gel or gel-like composition does not contain a non-functional structuring or thickening agent.

10. The method according to claim 1, wherein the gel or gel-like composition is a solid-in-liquid dispersion.

11. The method according to claim 1, wherein the gel or gel-like composition has a density of greater than 1 g/cm³.

12. A detergent composition prepared by a method according to claim 1.

13. The detergent composition according to claim 12, wherein the gel or gel-like composition is contained in a water-soluble pouch, preferably a multi-chamber water-soluble pouch.

14. A method of using a detergent composition according to claim 12 in an automatic dishwasher.
